(19) United States
(12) Patent Application Publication
(10) Pub. No.: US 2024/0076443 A1
(43) Pub. Date: Mar. 7, 2024

(54) LACTIDE COMPOSITIONS AND POLYLACTIDES MADE THEREFROM

(71) Applicant: NatureWorks LLC, Plymouth, MN (US)

(72) Inventor: Joseph David Schroeder, Minneapolis, MN (US)

(21) Appl. No.: 18/506,242

(22) Filed: Nov. 10, 2023

(51) Int. Cl. C08G 63/08

(52) U.S. Cl. CPC C08G 63/08

(57) ABSTRACT

Lactide compositions contain enumerated amounts of one or more impurities. The lactide compositions can be polymerized to form good quality polylactides despite the presence of these impurities. Some of the impurities pass through the polymerization process whereas some are partially or entirely removed and are therefore present in reduced quantities in the polymer if present at all. Conversely, some impurities are concentrated in the polymer.

This invention relates to lactide compositions and polylactides made therefrom.

Polylactides are made at industrial scale by polymerizing lactide. Lactide itself is produced by forming a low molecular weight polymer of lactic acid and depolymerizing that low molecular weight polymer. It is commonly thought that the lactide must be purified to a very high degree to be useful in producing good quality, high molecular weight polylactide resins. It has now been discovered that certain impurities can not only be tolerated in the lactide but may even be beneficial.

This invention is a lactide composition comprising lactide and, per million parts by weight of lactide, any one or more of:
a) 1 to 1000, 1 to 500 or 1 to 250 parts by weight 4-hydroxy-5-methyl-4-cyclopentene-1,3-dione;
b) 1 to 1000, 5 to 500 or 5 to 250 parts by weight 4-methyl-2,4-oxazolinedione;
c) 0.1 to 1000, 1 to 500 or 1 to 250 parts by weight 4-methoxy-6-methyl-5,6-dihydro-2H-pyran-2-one;
d) 0.05 to 25, 0.1 to 10 or 0.1 to 2 parts by weight gibpyrone F; and
e) 0.1 to 3000, 1 to 2500, 1 to 2000 or 1 to 1000 parts by weight 4,5-dimethyl-3-hydroxyl-2,5-dihydrofuran-2-one;

The presence and amount of each of compounds a)-e) is conveniently determined by diluting the sample in a suitable solvent and analyzing by liquid chromatography with an ultraviolet light detector.

This invention is also lactide composition comprising lactide and, per million parts by weight of lactide, any one or more of:
f) 1 to 1000, 1 to 500 or 1 to 250 parts by weight 5-acetyltetrahydrofuran-2-one;
g) 0.1 to 200, 0.1 to 100, 1 to 100 parts by weight dihydro-3-hydroxy-4,4-dimethyl-2(3H)-furanone; and
h) 0.1 to 500, 0.1 to 500, 1 to 250 parts by weight dihydro-3-hydroxy-2(3H)-furanone.

The presence and amount of each of compounds f)-h) is conveniently determined by diluting the sample in a suitable solvent and analyzing by gas chromatography with mass spectrometry detection.

This invention is also a lactide composition comprising lactide and one or more of diols selected from 1,2-propane diol, ethylene glycol, 2,3-butane diol and 2,3-pentanediol, and or compounds of one or more of such diols, such as mono- and/or diesters thereof. Mono- and/or diesters may be lactic acid mono- or diesters or mono- or di-lactoyllactic acid esters thereof. The amounts of such diols and/or compounds of such diols is conveniently expressed in terms of the amounts of such diols obtained by hydrolysis. The lactide composition in some embodiments comprises lactide and, per million parts by weight of lactide, any one or more of the following:
i) 0.1 to 100, 1 to 50 or 1 to 30 parts by weight 1,2-propanediol and/or residues thereof;
j) 1 to 100, 5 to 50 or 5 to 30 parts by weight ethylene glycol and/or residues thereof;
k) 1 to 5000, 1 to 1000, 10 to 1000 or 100 to 1000 parts by weight 2,3-butanediol and/or residues thereof; and
l) 1 to 500, 1 to 200 or 20 to 150 parts by weight 2,3-pentanediol and/or residues thereof.

“Residues” of any of the foregoing diols are groups in a larger molecule that, upon hydrolysis and/or methanolysis, produce the diol. For example, the dilactic acid ester of 1,2-propanediol contains a 1,2-propanediol residue, as does the monolactic ester of 1,2-propandiol. For calculating the concentration of the residue of any of these diols, the weight of the diol and residues is that amount of that diol which is recovered upon complete hydrolysis of the lactide sample. The amount of the diols and/or residues is conveniently determined by hydrolyzing the lactide sample followed by analyzing by gas chromatography with flame ionization detection.

This invention is also a lactide composition comprising lactide and one or more of monoacids selected from formic acid, acetic acid, pyruvic acid, n-butyric acid, levulinic acid, tetrahydro-1-furoic acid, glycolic acid, 2-hydroxybutyric acid, 3-methyl-2-hydroxybutyric acid, 3-methyl-2-hydroxyvaleric acid, and 2-hydroxyisocaproic acid, and/or compounds of one or more of such acid, such as esters thereof and/or anhydrides thereof. Mono- and/or diesters may be lactyl or lactoyllactyl esters of any one or more of the foregoing acids, and/or esters of any of the foregoing acids with any of the diols mentioned above. The amounts of such acid and/or compounds of such acid is conveniently expressed in terms of the amounts of such acids obtained by hydrolysis. The lactide composition in some embodiments comprises lactide and, per million parts by weight of lactide, any one or more of the following:
m) 1 to 1000, 1 to 250 or 1 to 100 parts by weight formic acid and/or residues thereof;
n) 1 to 1000, 10 to 500 or 10 to 250 parts by weight acetic acid and/or residues thereof;
o) 1 to 2000, 1 to 1000 or 10 to 500 parts by weight pyruvic acid and/or residues thereof;
p) 0.1 to 100 or 0.1 to 20 parts by weight n-butyric acid and/or residues thereof;
q) 0.1 to 100 or 0.1 to 50 parts by weight levulinic acid and/or residues thereof;
r) 0.1 to 100 or 0.1 to 25 parts by weight tetrahydro-1-furoic acid and/or residues thereof;
s) 0.1 to 500, 0.1 to 250 or 10 to 250 parts by weight by glycolic acid and/or residues thereof;
t) 1 to 5000, 1 to 1000, or 10 to 500 parts or 50 to 500 parts by weight by 2-hydroxybutyric acid and/or residues thereof;
u) 1 to 1000, or 1 to 500 parts by weight 3-methyl-2-hydroxylbutyric acid and/or residues thereof;
v) 0.1 to 250, 0.1 to 200 or 1 to 150 parts by weight 3-methyl-2-hydroxyvaleric acid and/or residues thereof and
w) 0.1 to 1000, 0.1 to 500, or 1 to 250 parts by weight 2-hydroxyisocaproic acid and/or residues thereof;

“Residues” of any of the foregoing acids are groups in a larger molecule that, upon hydrolysis, produce the acid. For example, lactyl formate contains a formic acid residue, lactyl acetate contains an acetic acid residue. For calculating the concentration of the residue of any of these acids, the weight of the acid and residues is that amount of that acid which is recovered upon complete hydrolysis of the lactide sample. The amount of the acids and/or residues is conveniently determined by hydrolyzing the lactide sample followed by derivation with methanol to produce methyl esters and analyzing by gas chromatography with flame ionization detection.

This invention is also a lactide composition comprising lactide and one or more of diacids selected from succinic acid, 2-methyl succinic acid, chiral 2,2′-oxybis[propanoic acid], meso 2,2′-oxybis[propanoic acid] and α-hydroxyglutaric acid, and/or compounds of one or more of such acid, such as esters thereof and/or anhydrides thereof. Esters may be mono- and/or di-esters Mono- and/or diesters may be lactyl and/or lactoyllactyl esters of any one or more of the foregoing diacids, and or mono- and-or diesters of any of the foregoing diacids with any of the diols mentioned above. The amounts of such acid and/or compounds of such acid is conveniently expressed in terms of the amounts of such acids obtained by hydrolysis. The lactide composition in some embodiments comprises lactide and, per million parts by weight of lactide, any one or more of the following:
x) 1 to 2500, 10 to 1500, 10 to 500 or 10 to 250 parts by weight succinic acid and/or residues thereof;
y) 0.1 to 1500, 1 to 1500 or 1 to 1000 parts by 2-methylsuccinic acid and/or residues thereof;
z) 1 to 500, 1 to 250 or 1 to 150 parts by weight chiral 2,2′-oxybis[propanoic acid] and/or residues thereof;
aa) 1 to 500, 1 to 350 or 1 to 250 parts by weight meso 2,2′-oxybis[propanoic acid] and/or residues thereof; and
bb) 0.1 to 100, 0.1 to 50 or 0.1 to 25 parts by weight α-hydroxyglutaric acid and/or residues thereof.

As before, “residues” of any of the foregoing acids are groups in a larger molecule that, upon hydrolysis, produce the acid. For example, mono lactyl succinate contains a succinic acid residue, as does dilactyl succinate. For calculating the concentration of the residue of any of these diacids, the weight of the diacid and residues is that amount of that diacid which is recovered upon complete hydrolysis of the lactide sample. The amount of the diacid and/or residues is conveniently determined by hydrolyzing the lactide sample followed by derivation with methanol to produce methyl esters and analyzing by gas chromatography with flame ionization detection.

Lactide compositions of the invention may contain any or all of impurities a)-bb), in the amounts (of the impurity and/or residues thereof) indicated above.

Lactides according to the invention are conveniently made by polymerizing lactic acid, the lactic acid itself preferably being produced in a fermentation process using a sugar source such as glucose, dextrose and sucrose. The sugar source can be derived from annually renewable crops such as corn, rice, sugar cane, beet sugar and other starchy or sugar-rich crop.

Lactide is produced by polymerizing lactic acid in the presence of a depolymerization catalyst such as a tin octoate or other tin catalyst. The polymerization and depolymerization reactions being equilibrium reactions, the reaction be driven towards lactide formation by removing lactide as it is formed. This can be done by distillation. Various impurities distill over with the lactide, including water and the impurities identified as a)-bb) above. Water can be reduced to very low levels via additional distillation steps, but one or more of impurities a)-bb) often remain with the lactide even after rigorous distillation, in amounts as indicated above. These impurities can be taken over to polymerization to produce polylactide.

The impurities in some instances are carried into the process with the starting lactic acid and in some cases are reaction by-products produced during the lactide manufacturing process and/or distillation steps.

Suitable processes for producing lactide by polymerizing and depolymerizing lactide acid, purifying lactide by distillation and polymerizing lactide to produce polylactides are described, for example, in U.S. Pat. No. 5,258,488 and EP 3 406 605B.

Some or all of the foregoing impurities remain with the polylactide resin after the lactide is polymerized. Therefore, in a second aspect, this invention is a polylactide resin composition comprising polylactide, 0.001 to 1 part by weight lactide per 100 parts by weight of the polylactide and, per million parts by weight lactide, any one or more of:
a) 1 to 1000, 1 to 500 or 1 to 250 parts by weight 4-hydroxy-5-methyl-4-cyclopentene-1,3-dione;
b) 1 to 1000, 5 to 500 or 5 to 250 parts by weight 4-methyl-2,4-oxazolinedione;
c) 0.1 to 1000, 1 to 500 or 1 to 250 parts by weight 4-methoxy-6-methyl-5,6-dihydro-2H-pyran-2-one;
d) 0.05 to 25, 0.1 to 10 or 0.1 to 2 parts by weight gibpyrone F; and
e) 0.1 to 3000, 1 to 2500, 1 to 2000 or 1 to 1000 parts by weight 4,5-dimethyl-3-hydroxyl-2,5-dihydrofuran-2-one;
f) 1 to 1000, 1 to 500 or 1 to 250 parts by weight 5-acetyltetrahydrofuran-2-one;
g) 0.1 to 200, 0.1 to 100, 1 to 100 parts by weight dihydro-3-hydroxy-4,4-dimethyl-2(3H)-furanone; and
h) 0.1 to 500, 0.1 to 500, 1 to 250 parts by weight dihydro-3-hydroxy-2(3H)-furanone.
i) 0.1 to 100, 1 to 50 or 1 to 30 parts by weight 1,2-propanediol and/or residues thereof;
j) 1 to 100, 5 to 50 or 5 to 30 parts by weight ethylene glycol and/or residues thereof;
k) 1 to 5000, 1 to 1000, 10 to 1000 or 100 to 1000 parts by weight 2,3-butanediol and/or residues thereof; and
l) 1 to 500, 1 to 200 or 20 to 150 parts by weight 2,3-pentanediol and/or residues thereof.
m) 1 to 1000, 1 to 250 or 1 to 100 parts by weight formic acid and/or residues thereof;
n) 1 to 1000, 10 to 500 or 10 to 250 parts by weight acetic acid and/or residues thereof;
o) 1 to 2000, 1 to 1000 or 10 to 500 parts by weight pyruvic acid and/or residues thereof;
p) 0.1 to 100 or 0.1 to 20 parts by weight n-butyric acid and/or residues thereof;
q) 0.1 to 100 or 0.1 to 50 parts by weight levulinic acid and/or residues thereof;
r) 0.1 to 100 or 0.1 to 25 parts by weight tetrahydro-1-furoic acid and/or residues thereof;
s) 0.1 to 500, 0.1 to 250 or 10 to 250 parts by weight by glycolic acid and/or residues thereof;
t) 1 to 5000, 1 to 1000, or 10 to 500 parts or 50 to 500 parts by weight by 2-hydroxybutyric acid and/or residues thereof;
u) 1 to 1000, or 1 to 500 parts by weight 3-methyl-2-hydroxylbutyric acid and/or residues thereof;
v) 0.1 to 250, 0.1 to 200 or 1 to 150 parts by weight 3-methyl-2-hydroxyvaleric acid and/or residues thereof and
w) 0.1 to 1000, 0.1 to 500, or 1 to 250 parts by weight 2-hydroxyisocaproic acid and/or residues thereof;
x) 1 to 2500, 10 to 1500, 10 to 500 or 10 to 250 parts by weight succinic acid and/or residues thereof;
y) 0.1 to 1500, 1 to 1500 or 1 to 1000 parts by 2-methylsuccinic acid and/or residues thereof;
z) 1 to 500, 1 to 250 or 1 to 150 parts by weight chiral 2,2′-oxybis[propanoic acid] and/or residues thereof;
aa) 1 to 500, 1 to 350 or 1 to 250 parts by weight meso 2,2′-oxybis[propanoic acid] and/or residues thereof; and
bb) 0.1 to 100, 0.1 to 50 or 0.1 to 25 parts by weight α-hydroxyglutaric acid and/or residues thereof.

The amounts of these compounds and resides can be determined using the same methods as for the lactide compositions.

In a third aspect, the invention is a polylactide having a nitrogen content of 1500 to 10,000 parts per million. Such a polylactide is conveniently prepared by producing a polylactide oligomer having a number average molecular weight of, for example, 5,000 to 20,000 g/mol having terminal hydroxyl and/or carboxylic acid groups, and chain-extending the oligomers with a polyisocyanate and/or a polyoxazoline.

### EXAMPLES

Lactide is produced by polymerizing and depolymerizing lactic acid produced by fermenting corn-derived dextrose. Four different grades are produced, having levels of impurities a)-bb) (and/or residues thereof) as indicated in the following table. The amounts for each impurities (and/or residue) is determined using the appropriate method described before.

TABLE
Impurity Analysis in Lactides

Parts Per Million

| Impurity | Lactide 1 | Lactide 2 | Lactide 3 | Lactide 4 |
|---|---|---|---|---|
| a* | 36-204 | 36-204 | 36-204 | 36-204 |
| b* | <125 | <125 | <125 | <125 |
| c* | 3-175 | 3-175 | 3-175 | 3-175 |
| d* | 0.5-2 | 0.5-2 | 0.5-2 | 0.5-2 |
| e** | 7-35 | — | — | 7-35 |
| f** | — | 1-10 | — | — |
| g** | 39-58 | 39-46 | 37-45 | |
| h** | 22-29 | 25-28 | 28-32 | |
| i** | <8 | <25 | <25 | <15 |
| j** | <11 | <25 | <25 | <17 |
| k** | 98-513 | 260-506 | 17-132 | 124-512 |
| l** | 21-119 | 14-49 | 12-36 | 24-93 |
| m** | 20-67 | 20-58 | 20-68 | 20-57 |
| n** | 22-221 | 22-114 | 32-190 | 20-195 |
| o** | 44-251 | 20-74 | 42-152 | 58-222 |
| p** | 0.1-20 | 0.1-20 | 0.1-20 | 0.1-20 |
| q** | 0-20 | 26-43 | 0-20 | 0-20 |
| r** | 0-20 | 0-20 | 0-20 | 0-20 |
| s** | 18-143 | 0-20 | 10-27 | 38-119 |
| t** | 298-442 | 81-127 | 295-434 | 288-406 |
| u** | 46-93 | 226-275 | 0-20 | 10-107 |
| v** | 73-95 | 0-20 | 0-20 | 73-112 |
| w** | 128-202 | 0-20 | 0-20 | 576-178 |
| x** | 0-20 | 0-20 | 0-20 | 22-39 |
| y** | 21-75 | 79-97 | 0-20 | 42-1030 |
| z** | 23-49 | 414-806 | 0-20 | 20-122 |
| aa** | 23-49 | 55-100 | 0-20 | 26-87 |
| bb** | 22-39 | 103-191 | 0-20 | 21-90 |

*Ranges represent typical values for all lactide samples.
**Ranges represent typical values for the lactide sample indicated.

Polylactides are made by polymerizing mixtures of the foregoing lactides as indicated in the next table and devolatilizing the product to reduce the residual lactide amount to less than 0.3% by weight. The amounts of impurities a-bb) (and/or residues thereof) are measured using the appropriate method described before.

| | PLA 1 | PLA 2 | PLA 3 |
|---|---|---|---|
| Lactide | 60% lactide 1/ | 92% lactide 1/ | 80% lactide 4/ |
| Composition | 40% lactide 3 | 8% lactide 2 | 20% lactide 2 |
| Impurity | Parts by weight | | |
| a-h | Present, not quantified (measured in lactide feeds) | | |
| i | 100-170 | 43-73 | 12-19 |
| j | 100-187 | 14-18 | 9-10 |
| k | 44-114 | 115-171 | 166-211 |
| l | 220-422 | 23-30 | 27-34 |
| m-r | Present, not quantified (measured in lactide feeds) | | |
| s | 151-252 | 169-209 | 172-268 |
| t | 697-1060 | 474-639 | 619-789 |
| u | 80-118 | 87-127 | 168-185 |
| v | 94-158 | 80-138 | 103-147 |
| w | 210-347 | 144-256 | 164-235 |
| x | Present, not quantified (measured in lactide feeds) | | |
| y | 25-34 | 0 | 24-32 |
| z | Present, not quantified (measured in lactide feeds) | | |
| aa | 39-58 | 39-46 | 37-45 |
| ab | 22-29 | 25-28 | 28-32 |

What is claimed is:

1. A lactide composition comprising lactide and, per million parts by weight of lactide, any one or more of:
a) 1 to 1000, 1 to 500 or 1 to 250 parts by weight 4-hydroxy-5-methyl-4-cyclopentene-1,3-dione;
b) 1 to 1000, 5 to 500 or 5 to 250 parts by weight 4-methyl-2,4-oxazolinedione;
c) 0.1 to 1000, 1 to 500 or 1 to 250 parts by weight 4-methoxy-6-methyl-5,6-dihydro-2H-pyran-2-one;
d) 0.05 to 25, 0.1 to 10 or 0.1 to 2 parts by weight gibpyrone F; and
e) 0.1 to 3000, 1 to 2500, 1 to 2000 or 1 to 1000 parts by weight 4,5-dimethyl-3-hydroxyl-2,5-dihydrofuran-2-one.

2. A lactide composition of claim 1 further comprising, per million parts by weight of lactide, any one or more of:
f) 1 to 1000, 1 to 500 or 1 to 250 parts by weight 5-acetyltetrahydrofuran-2-one;
g) 0.1 to 200, 0.1 to 100, 1 to 100 parts by weight dihydro-3-hydroxy-4,4-dimethyl-2(3H)-furanone; and
h) 0.1 to 500, 0.1 to 500, 1 to 250 parts by weight dihydro-3-hydroxy-2(3H)-furanone.

3. A lactide composition of claim 1 further comprising one or more of diols selected from 1,2-propane diol, ethylene glycol, 2,3-butane diol and 2,3-pentanediol, and or compounds of one or more of such diols, such as mono- and/or diesters thereof.

4. The lactide composition of claim 3 which comprises lactide and, per million parts by weight of lactide, any one or more of the following:
i) 0.1 to 100, 1 to 50 or 1 to 30 parts by weight 1,2-propanediol and/or residues thereof;
j) 1 to 100, 5 to 50 or 5 to 30 parts by weight ethylene glycol and/or residues thereof;
k) 1 to 5000, 1 to 1000, 10 to 1000 or 100 to 1000 parts by weight 2,3-butanediol and/or residues thereof; and
l) 1 to 500, 1 to 200 or 20 to 150 parts by weight 2,3-pentanediol and/or residues thereof.

5. The lactide composition of claim 1 further comprising one or more of monoacids selected from formic acid, acetic acid, pyruvic acid, n-butyric acid, levulinic acid, tetrahydro-1-furoic acid, glycolic acid, 2-hydroxybutyric acid, 3-methyl-2-hydroxybutyric acid, 3-methyl-2-hydroxyvaleric acid, and 2-hydroxyisocaproic acid, and/or compounds of one or more of such acid, such as esters thereof and/or anhydrides thereof.

6. The lactide composition of claim 6 further comprising, per million parts by weight of lactide, any one or more of the following:
m) 1 to 1000, 1 to 250 or 1 to 100 parts by weight formic acid and/or residues thereof;
n) 1 to 1000, 10 to 500 or 10 to 250 parts by weight acetic acid and/or residues thereof;
o) 1 to 2000, 1 to 1000 or 10 to 500 parts by weight pyruvic acid and/or residues thereof;
p) 0.1 to 100 or 0.1 to 20 parts by weight n-butyric acid and/or residues thereof;
q) 0.1 to 100 or 0.1 to 50 parts by weight levulinic acid and/or residues thereof;
r) 0.1 to 100 or 0.1 to 25 parts by weight tetrahydro-1-furoic acid and/or residues thereof;
s) 0.1 to 500, 0.1 to 250 or 10 to 250 parts by weight by glycolic acid and/or residues thereof;
t) 1 to 5000, 1 to 1000, or 10 to 500 parts or 50 to 500 parts by weight by 2-hydroxybutyric acid and/or residues thereof;
u) 1 to 1000, or 1 to 500 parts by weight 3-methyl-2-hydroxylbutyric acid and/or residues thereof;
v) 0.1 to 250, 0.1 to 200 or 1 to 150 parts by weight 3-methyl-2-hydroxyvaleric acid and/or residues thereof and
w) 0.1 to 1000, 0.1 to 500, or 1 to 250 parts by weight 2-hydroxyisocaproic acid and/or residues thereof;

7. The lactide composition of claim 1 further comprising one or more of diacids selected from succinic acid, 2-methyl succinic acid, chiral 2,2′-oxybis[propanoic acid], meso 2,2′-oxybis[propanoic acid] and α-hydroxyglutaric acid, and/or compounds of one or more of such acid, such as esters thereof and/or anhydrides thereof.

8. The lactide composition of claim 7 further comprising, per million parts by weight of lactide, any one or more of the following:
x) 1 to 2500, 10 to 1500, 10 to 500 or 10 to 250 parts by weight succinic acid and/or residues thereof;
y) 0.1 to 1500, 1 to 1500 or 1 to 1000 parts by 2-methylsuccinic acid and/or residues thereof;
z) 1 to 500, 1 to 250 or 1 to 150 parts by weight chiral 2,2′-oxybis[propanoic acid] and/or residues thereof;
aa) 1 to 500, 1 to 350 or 1 to 250 parts by weight meso 2,2′-oxybis[propanoic acid] and/or residues thereof; and
bb) 0.1 to 100, 0.1 to 50 or 0.1 to 25 parts by weight α-hydroxyglutaric acid and/or residues thereof.

9. A polylactide made by polymerizing the lactide composition of claim 1.

10. A polylactide made by polymerizing the lactide composition of claim 2.

11. A polylactide made by polymerizing the lactide composition of claim 4.

12. A polylactide made by polymerizing the lactide composition of claim 6.

13. A polylactide made by polymerizing the lactide composition of claim 8.

14. A polylactide resin composition comprising polylactide, 0.001 to 1 part by weight lactide per 100 parts by weight of the polylactide and, per million parts by weight lactide, any one or more of:
a) 1 to 1000, 1 to 500 or 1 to 250 parts by weight 4-hydroxy-5-methyl-4-cyclopentene-1,3-dione;
b) 1 to 1000, 5 to 500 or 5 to 250 parts by weight 4-methyl-2,4-oxazolinedione;
c) 0.1 to 1000, 1 to 500 or 1 to 250 parts by weight 4-methoxy-6-methyl-5,6-dihydro-2H-pyran-2-one;
d) 0.05 to 25, 0.1 to 10 or 0.1 to 2 parts by weight gibpyrone F; and
e) 0.1 to 3000, 1 to 2500, 1 to 2000 or 1 to 1000 parts by weight 4,5-dimethyl-3-hydroxyl-2,5-dihydrofuran-2-one;
f) 1 to 1000, 1 to 500 or 1 to 250 parts by weight 5-acetyltetrahydrofuran-2-one;
g) 0.1 to 200, 0.1 to 100, 1 to 100 parts by weight dihydro-3-hydroxy-4,4-dimethyl-2(3H)-furanone; and
h) 0.1 to 500, 0.1 to 500, 1 to 250 parts by weight dihydro-3-hydroxy-2(3H)-furanone.
i) 0.1 to 100, 1 to 50 or 1 to 30 parts by weight 1,2-propanediol and/or residues thereof;
j) 1 to 100, 5 to 50 or 5 to 30 parts by weight ethylene glycol and/or residues thereof;
k) 1 to 5000, 1 to 1000, 10 to 1000 or 100 to 1000 parts by weight 2,3-butanediol and/or residues thereof; and
l) 1 to 500, 1 to 200 or 20 to 150 parts by weight 2,3-pentanediol and/or residues thereof.
m) 1 to 1000, 1 to 250 or 1 to 100 parts by weight formic acid and/or residues thereof;
n) 1 to 1000, 10 to 500 or 10 to 250 parts by weight acetic acid and/or residues thereof;
o) 1 to 2000, 1 to 1000 or 10 to 500 parts by weight pyruvic acid and/or residues thereof;
p) 0.1 to 100 or 0.1 to 20 parts by weight n-butyric acid and/or residues thereof;
q) 0.1 to 100 or 0.1 to 50 parts by weight levulinic acid and/or residues thereof;
r) 0.1 to 100 or 0.1 to 25 parts by weight tetrahydro-1-furoic acid and/or residues thereof;
s) 0.1 to 500, 0.1 to 250 or 10 to 250 parts by weight by glycolic acid and/or residues thereof;
t) 1 to 5000, 1 to 1000, or 10 to 500 parts or 50 to 500 parts by weight by 2-hydroxybutyric acid and/or residues thereof;
u) 1 to 1000, or 1 to 500 parts by weight 3-methyl-2-hydroxylbutyric acid and/or residues thereof;
v) 0.1 to 250, 0.1 to 200 or 1 to 150 parts by weight 3-methyl-2-hydroxyvaleric acid and/or residues thereof;
w) 0.1 to 1000, 0.1 to 500, or 1 to 250 parts by weight 2-hydroxyisocaproic acid and/or residues thereof;
x) 1 to 2500, 10 to 1500, 10 to 500 or 10 to 250 parts by weight succinic acid and/or residues thereof;
y) 0.1 to 1500, 1 to 1500 or 1 to 1000 parts by 2-methylsuccinic acid and/or residues thereof;
z) 1 to 500, 1 to 250 or 1 to 150 parts by weight chiral 2,2′-oxybis[propanoic acid] and/or residues thereof;
aa) 1 to 500, 1 to 350 or 1 to 250 parts by weight meso 2,2′-oxybis[propanoic acid] and/or residues thereof; and
bb) 0.1 to 100, 0.1 to 50 or 0.1 to 25 parts by weight α-hydroxyglutaric acid and/or residues thereof.

15. A polylactide having a nitrogen content of 1500-10,000 parts per million.
